(19) United States
(12) Patent Application Publication
(10) Pub. No.: US 2022/0156157 A1
(43) Pub. Date: May 19, 2022

(54) USER-DRIVEN RECOVERY OF LOST CONTENT

(71) Applicant: AT&T Intellectual Property I, L.P., Atlanta, GA (US)

(72) Inventors: Christopher Weaver, Franklin, TN (US); Eric Zavesky, Austin, TX (US); Subhabrata Majumdar, Jersey City, NJ (US)

(21) Appl. No.: 16/950,843

(22) Filed: Nov. 17, 2020

(51) Int. Cl. G06F 11/14; H04L 29/08; G06F 16/41

(52) U.S. Cl. CPC G06F 11/1469; G06F 2201/80; G06F 16/41; H04L 67/22

(57) ABSTRACT

An example method includes recording a copy of an item of media content, comparing the copy of the item of media content to a stored fingerprint for the item of media content, determining that the copy of the item of media content is missing a portion of the item of media content, based on the comparing, retrieving the portion of the item of media content that is missing, incorporating the portion of the item of media content that is missing into the copy of the item of media content, and storing the copy of the item of media content, including the portion of the item of media content that is missing.

The present disclosure relates generally to media distribution, and relates more particularly to devices, non-transitory computer-readable media, and methods for recovering lost media content.

### BACKGROUND

Consumers (e.g., users of media content, hereinafter also referred to as simply “users”) are being presented with an ever increasing number of services via which media content can be accessed and enjoyed. For instance, streaming video and audio services, video on demand services, social media, and the like are offering more forms of content (e.g., short-form, always-on, raw sensor feed, etc.) and a greater number of distribution channels (e.g., mobile channels, social media channels, streaming channels, just-in-time on-demand channels, etc.) than have ever been available in the past. As the number of choices available to users increases and diversifies, service providers seeking to retain their customer bases are looking for ways to increase the engagement of their customers with their content.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for recovering lost media content may operate;

FIG. 2 illustrates a flowchart of an example method for generating a fingerprint for an item of media content, in accordance with the present disclosure;

FIG. 3 illustrates a flowchart of an example method for recovering lost media content, in accordance with the present disclosure; and

FIG. 4 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for recovering lost media content. In one example, a method performed by a processing system includes recording a copy of an item of media content, comparing the copy of the item of media content to a stored fingerprint for the item of media content, determining that the copy of the item of media content is missing a portion of the item of media content, based on the comparing, retrieving the portion of the item of media content that is missing, incorporating the portion of the item of media content that is missing into the copy of the item of media content, and storing the copy of the item of media content, including the portion of the item of media content that is missing.

In another example, a non-transitory computer-readable medium may store instructions which, when executed by a processing system in a communications network, cause the processing system to perform operations. The operations may include recording a copy of an item of media content, comparing the copy of the item of media content to a stored fingerprint for the item of media content, determining that the copy of the item of media content is missing a portion of the item of media content, based on the comparing, retrieving the portion of the item of media content that is missing, incorporating the portion of the item of media content that is missing into the copy of the item of media content, and storing the copy of the item of media content, including the portion of the item of media content that is missing.

In another example, a device may include a processing system including at least one processor and non-transitory computer-readable medium storing instructions which, when executed by the processing system when deployed in a communications network, cause the processing system to perform operations. The operations may include recording a copy of an item of media content, comparing the copy of the item of media content to a stored fingerprint for the item of media content, determining that the copy of the item of media content is missing a portion of the item of media content, based on the comparing, retrieving the portion of the item of media content that is missing, incorporating the portion of the item of media content that is missing into the copy of the item of media content, and storing the copy of the item of media content, including the portion of the item of media content that is missing.

As discussed above, as the number of services via which users may access media content increases and diversifies, service providers seeking to retain their customer bases are looking for ways to increase the engagement of their customers with their content. The advent of the digital video recorder (DVR) has helped to increase user engagement with visual media (e.g., television shows, movies, televised sports events, etc.) by allowing users to watch the media on their own time, regardless of when the media may be scheduled to air. For instance, a user may program his DVR to record an episode of his favorite television show, which is scheduled to air at a time when the user knows he will not be home. Later, when the user has returned home and has sufficient time to watch the episode, he may retrieve the episode from the DVR.

However, DVRs are not perfect. Most DVRs determine when to record content based on a predefined schedule, which may be provided by a service provider (e.g., a cable television service provider, a satellite television service provider, or the like). For instance, the schedule may indicate that an episode of a particular television show that the user wishes to record is set to air starting at 9:00 PM and ending at 10:00 PM on Monday. However, the actual airing of the episode may not align perfectly with the scheduled time slot. For instance, a program preceding the episode on the same channel may run over its scheduled time (e.g., as in the case of a breaking news story, a football game that goes into overtime, or the like) and cause the start of the episode (and, thus, the rest of the episode) to be delayed unexpectedly or indefinitely. If the DVR simply records the channel content from 9:00 PM to 10:00 PM, the DVR will likely end up recording the end of the preceding program, and the end of the episode that was meant to be recorded may be cut off. Similar situations may occur in cases where the episode run time is longer than usual (e.g., most episodes of the show may have a run time of about one hour, but this episode may have a run time of about one hour and two minutes), where the order of specific segments of the media is changed (e.g., a news program moves a regular segment from the beginning of the broadcast to the middle), and in other cases with different circumstances. The end result is that at least some of the media that the user wanted to record may be missing, which may be frustrating to the user and lead to dissatisfaction and/or diminished engagement with the media.

Examples of the present disclosure may utilize machine learning techniques in order to identify scene changes in visual media (e.g., television shows, movies, televised sports events, etc.), where the scene changes may indicate transitions from one program to another (e.g., a first television show to a second television show) or from one portion of a program to another (e.g., from a musical performance on a late night show to an interview on the same late night show). Identifying the scene changes may help a DVR to determine where the boundaries of different programs are and, when necessary, to retain in memory media that may be aired outside of a scheduled recording time. For instance, a football game may run into overtime, delaying the start of an hour-long television program that is scheduled to air after the game by twenty minutes. Conventional DVR recording techniques would typically end up recording the last twenty minutes of the football game and only the first forty minutes of the television program (thereby losing the last twenty minutes of the television program). However, examples of the techniques disclosed herein may be able to detect when the football game ends and the television program begins, and when the television program ends and a next program begins, based on scene changes (e.g., a set of a police procedural drama looks different than a football field or a set for a late night show). The DVR may then store the portions of a recording that occur between the detected scene changes, thereby ensuring that the recording of the television program is complete despite the unscheduled changes in programming.

In further examples, similar techniques could be used to detect the boundaries of specific portions of media to be recorded. For instance a user may enjoy a particular regular segment of a comedy sketch show (e.g., a musical guest or a news program parody), but may be less interested in the other sketches. Similarly, a user may enjoy the interviews of a late night show, but be less interested in the opening monologues. The techniques disclosed herein could be used to facilitate recording of the portions of a program in which a user is interested, and cutting out of other portions of the program to minimize the need to fast forward through content the user does not wish to watch.

Although examples of the present disclosure are discussed within the context of visual media, it will be appreciated that the examples described herein could apply equally to non-visual media, or to media that does not have a visual component. For instance, examples of the present disclosure could be used to dynamically adapt a podcast, a streaming radio station, an audio book, or the like.

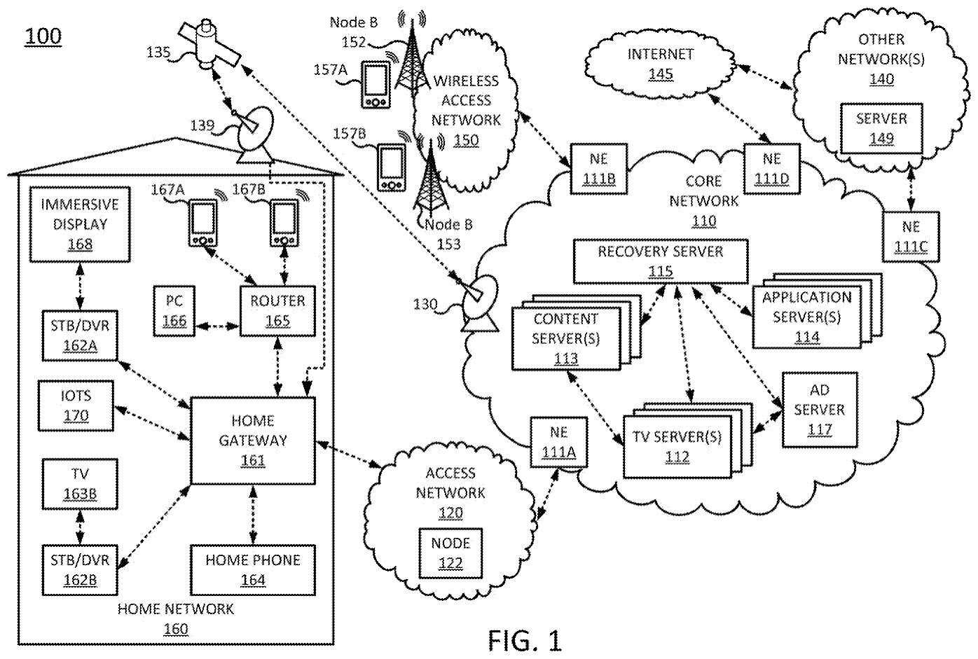

To better understand the present disclosure, FIG. 1 illustrates an example network 100, related to the present disclosure. As shown in FIG. 1, the network 100 connects mobile devices 157A, 157B, 167A and 167B, and home network devices such as home gateway 161, set-top boxes (STBs) 162A, and 162B, television (TV) 163, home phone 164, router 165, personal computer (PC) 166, immersive display 168, and so forth, with one another and with various other devices via a core network 110, a wireless access network 150 (e.g., a cellular network), an access network 120, other networks 140 and/or the Internet 145. In some examples, not all of the mobile devices and home network devices will be utilized in the adaptation of media content. For instance, in some examples, presentation of adaptive media may make use of the home network devices (e.g., immersive display 168, STB/DVR 162A, and/or Internet of Things devices (IoTs) 170), and may potentially also make use of any co-located mobile devices (e.g., mobile devices 167A and 167B), but may not make use of any mobile devices that are not co-located with the home network devices (e.g., mobile devices 157A and 158A).

In one example, wireless access network 150 comprises a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, wireless access network 150 may comprise an access network in accordance with any “second generation” (2G), “third generation” (3G), “fourth generation” (4G), Long Term Evolution (LTE) or any other yet to be developed future wireless/cellular network technology including “fifth generation” (5G) and further generations. While the present disclosure is not limited to any particular type of wireless access network, in the illustrative example, wireless access network 150 is shown as a UMTS terrestrial radio access network (UTRAN) subsystem. Thus, elements 152 and 153 may each comprise a Node B or evolved Node B (eNodeB).

In one example, each of mobile devices 157A, 157B, 167A, and 167B may comprise any subscriber/customer endpoint device configured for wireless communication such as a laptop computer, a Wi-Fi device, a Personal Digital Assistant (PDA), a mobile phone, a smartphone, an email device, a computing tablet, a messaging device, a wearable smart device (e.g., a smart watch or fitness tracker), a gaming console, and the like. In one example, any one or more of mobile devices 157A, 157B, 167A, and 167B may have both cellular and non-cellular access capabilities and may further have wired communication and networking capabilities.

As illustrated in FIG. 1, network 100 includes a core network 110. In one example, core network 110 may combine core network components of a cellular network with components of a triple play service network; where triple play services include telephone services, Internet services and television services to subscribers. For example, core network 110 may functionally comprise a fixed mobile convergence (FMC) network, e.g., an IP Multimedia Subsystem (IMS) network. In addition, core network 110 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Core network 110 may also further comprise a broadcast television network, e.g., a traditional cable provider network or an Internet Protocol Television (IPTV) network, as well as an Internet Service Provider (ISP) network. The network elements 111A-111D may serve as gateway servers or edge routers to interconnect the core network 110 with other networks 140, Internet 145, wireless access network 150, access network 120, and so forth. As shown in FIG. 1, core network 110 may also include a plurality of television (TV) servers 112, a plurality of content servers 113, a plurality of application servers 114, an advertising server (AS) 117, and an recovery server 115 (e.g., an application server). For ease of illustration, various additional elements of core network 110 are omitted from FIG. 1.

In one example, recovery server 115 may generate fingerprints for items of media content. In one example, generating a fingerprint for an item of media content may involve performing video and/or audio analytics in order to extract salient segments from the item of media content. For instance, where the item of media content is a television show, a salient segment might comprise a scene in which a famous guest star appears or a scene that ends with a cliffhanger; where the item of media content is a comedy sketch show, a salient segment might comprise a news parody segment or a performance by a musical guest; where the item of media content is a movie, a salient segment might comprise a twist ending or a scene featuring three-dimensional effects; where the item of media content is a televised sports event, a salient segment might be a scoring play, a fight, a turnover, or a particularly memorable performance of the national anthem. In further examples, the recovery server may rely on user interest statistics to extract salient segments. For instance, the segments that were most replayed by users may be considered the most salient segments. Each salient segment may serve as a marker in the item of media content, and, collectively, all of the markers may form a fingerprint for the item of media content,

In some examples, the recovery server 115 may utilize the fingerprint for an item of media content in order to determine when a copy of the item of media content (e.g., as recorded by a DVR) is incomplete. For instance, video and/or audio analytics may be used to search the copy of the item of media content for each of the markers. If any markers are missing from the copy of the item of media content, then this may indicate that the copy of the item of media content is incomplete (e.g., due to portions of the item of media content airing outside of a scheduled time window), as well as indicate which specific portions of the item of media content are missing from the copy.

In some examples, the recovery server 115 may further retrieve the missing portions of the item of media content. The recovery server 115 may interact with television servers 112, content servers 113, and/or advertising server 117 (or with from third party data sources such as server 149 in other network 140), to retrieve missing portions of items of media content. The recovery server 115 may incorporate the retrieved portions into the copy of the item of media content so that the copy of the item of media content is complete.

The content servers 113 may store scheduled television broadcast content for a number of television channels, video-on-demand programming, local programming content, gaming content, and so forth. The content servers 113 may also store other types of media that are not audio/video in nature, such as audio-only media (e.g., music, audio books, podcasts, or the like) or video-only media (e.g., image slideshows). For example, content providers may upload various contents to the core network to be distributed to various subscribers. Alternatively, or in addition, content providers may stream various contents to the core network for distribution to various subscribers, e.g., for live content, such as news programming, sporting events, and the like. In one example, advertising server 117 stores a number of advertisements that can be selected for presentation to subscribers, e.g., in the home network 160 and at other downstream viewing locations. For example, advertisers may upload various advertising content to the core network 110 to be distributed to various viewers.

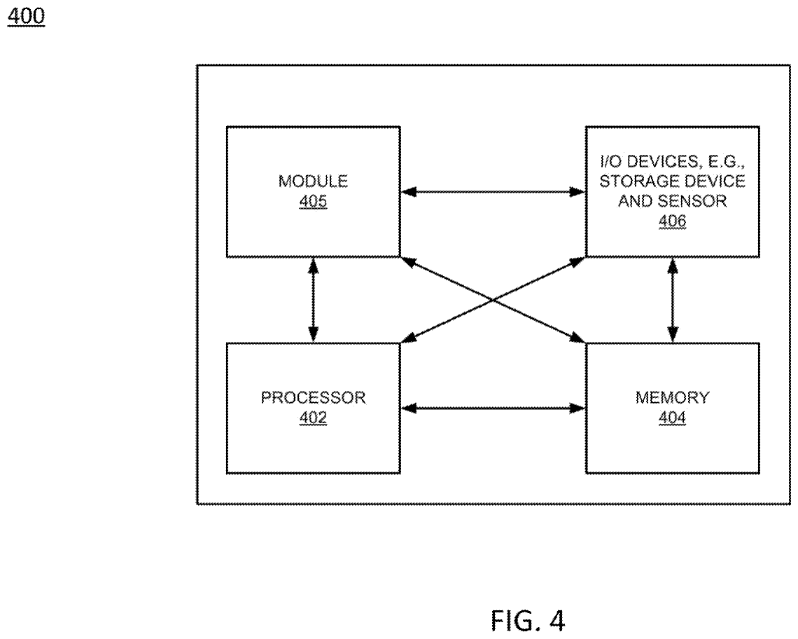

In one example, any or all of the television servers 112, content servers 113, application servers 114, recovery server 115, and advertising server 117 may comprise a computing system, such as computing system 400 depicted in FIG. 4.

In one example, the access network 120 may comprise a Digital Subscriber Line (DSL) network, a broadband cable access network, a Local Area Network (LAN), a cellular or wireless access network, a 3^{rd} party network, and the like. For example, the operator of core network 110 may provide a cable television service, an IPTV service, or any other type of television service to subscribers via access network 120. In this regard, access network 120 may include a node 122, e.g., a mini-fiber node (MFN), a video-ready access device (VRAD) or the like. However, in another example node 122 may be omitted, e.g., for fiber-to-the-premises (FTTP) installations. Access network 120 may also transmit and receive communications between home network 160 and core network 110 relating to voice telephone calls, communications with web servers via the Internet 145 and/or other networks 140, and so forth.

Alternatively, or in addition, the network 100 may provide television services to home network 160 via satellite broadcast. For instance, ground station 130 may receive television content from television servers 112 for uplink transmission to satellite 135. Accordingly, satellite 135 may receive television content from ground station 130 and may broadcast the television content to satellite receiver 139, e.g., a satellite link terrestrial antenna (including satellite dishes and antennas for downlink communications, or for both downlink and uplink communications), as well as to satellite receivers of other subscribers within a coverage area of satellite 135. In one example, satellite 135 may be controlled and/or operated by a same network service provider as the core network 110. In another example, satellite 135 may be controlled and/or operated by a different entity and may carry television broadcast signals on behalf of the core network 110.

In one example, home network 160 may include a home gateway 161, which receives data/communications associated with different types of media, e.g., television, phone, and Internet, and separates these communications for the appropriate devices. The data/communications may be received via access network 120 and/or via satellite receiver 139, for instance. In one example, television data is forwarded to set-top boxes (STBs)/digital video recorders (DVRs) 162A and 162B to be decoded, recorded, and/or forwarded to television (TV) 163 and/or immersive display 168 for presentation. Similarly, telephone data is sent to and received from home phone 164; Internet communications are sent to and received from router 165, which may be capable of both wired and/or wireless communication. In turn, router 165 receives data from and sends data to the appropriate devices, e.g., personal computer (PC) 166, mobile devices 167A and 167B, IoTs 170 and so forth.

In one example, router 165 may further communicate with TV (broadly a display) 163 and/or immersive display 168, e.g., where one or both of the television and the immersive display incorporates “smart” features. The immersive display may comprise a display with a wide field of view (e.g., in one example, at least ninety to one hundred degrees). For instance, head mounted displays, simulators, visualization systems, cave automatic virtual environment (CAVE) systems, stereoscopic three dimensional displays, and the like are all examples of immersive displays that may be used in conjunction with examples of the present disclosure. In other examples, an “immersive display” may also be realized as an augmentation of existing vision augmenting devices, such as glasses, monocles, contact lenses, or devices that deliver visual content directly to a user's retina (e.g., via mini-lasers or optically diffracted light). In further examples, an “immersive display” may include visual patterns projected on surfaces such as windows, doors, floors, or ceilings made of transparent materials.

In another example, the router 165 may further communicate with one or more IoTs 170, e.g., a connected security system, an automated assistant device or interface, a connected thermostat, a connected speaker system, or the like. In one example, router 165 may comprise a wired Ethernet router and/or an Institute for Electrical and Electronics Engineers (IEEE) 802.11 (Wi-Fi) router, and may communicate with respective devices in home network 160 via wired and/or wireless connections.

It should be noted that as used herein, the terms “configure” and “reconfigure” may refer to programming or loading a computing device with computer-readable/computer-executable instructions, code, and/or programs, e.g., in a memory, which when executed by a processor of the computing device, may cause the computing device to perform various functions. Such terms may also encompass providing variables, data values, tables, objects, or other data structures or the like which may cause a computer device executing computer-readable instructions, code, and/or programs to function differently depending upon the values of the variables or other data structures that are provided. For example, one or both of the STB/DVR 162A and STB/DVR 162B may host an operating system for presenting a user interface via TVs 163 and/or immersive display 168, respectively. In one example, the user interface may be controlled by a user via a remote control or other control devices which are capable of providing input signals to a STB/DVR. For example, mobile device 167A and/or mobile device 167B may be equipped with an application to send control signals to STB/DVR 162A and/or STB/DVR 162B via an infrared transmitter or transceiver, a transceiver for IEEE 802.11 based communications (e.g., “Wi-Fi”), IEEE 802.15 based communications (e.g., “Bluetooth”, “ZigBee”, etc.), and so forth, where STB/DVR 162A and/or STB/DVR 162B are similarly equipped to receive such a signal. Although STB/DVR 162A and STB/DVR 162B are illustrated and described as integrated devices with both STB and DVR functions, in other, further, and different examples, STB/DVR 162A and/or STB/DVR 162B may comprise separate STB and DVR components.

Those skilled in the art will realize that the network 100 may be implemented in a different form than that which is illustrated in FIG. 1, or may be expanded by including additional endpoint devices, access networks, network elements, application servers, etc. without altering the scope of the present disclosure. For example, core network 110 is not limited to an IMS network. Wireless access network 150 is not limited to a UMTS/UTRAN configuration. Similarly, the present disclosure is not limited to an IP/MPLS network for VoIP telephony services, or any particular type of broadcast television network for providing television services, and so forth.

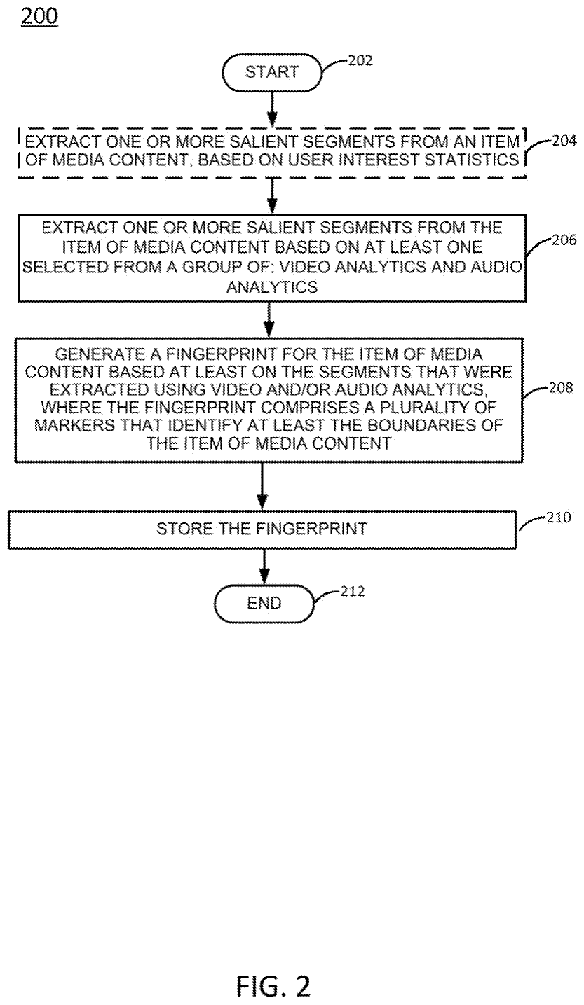

FIG. 2 illustrates a flowchart of an example method 200 for generating a fingerprint for an item of media content, in accordance with the present disclosure. As discussed above, a fingerprint for an item of media content may be used to determine whether a stored copy of the item of media content is complete, e.g., by comparing certain characteristics and/or markers of the stored copy to the fingerprint.

In one example, steps, functions and/or operations of the method 200 may be performed by a device as illustrated in FIG. 1, e.g., recovery server 115. In one example, the steps, functions, or operations of method 200 may be performed by a computing device or system 400, and/or a processing system 402 as described in connection with FIG. 4 below. For instance, the computing device 400 may represent at least a portion of the recovery server 115 in accordance with the present disclosure. For illustrative purposes, the method 200 is described in greater detail below in connection with an example performed by a processing system, such as processing system 402.

The method 200 begins in step 202 and proceeds to step 204. In optional step 204 (illustrated in phantom), the processing system may extract one or more salient segments from an item of media content, based on user interest statistics. In one example, the item of media content is an item of audio visual media such as might be presented on a television or other devices including a display. For instance, the item of media content may be an episode of a television show, a movie, a televised sports event, a news program, or the like. However, in other examples, the item of media content may not include a visual component. For instance, the item of media content could be a radio program (e.g., a top 40 countdown, a talk radio program, a radio broadcast of a sports event, or the like).

The salient segments may comprise portions or excerpts from the item of media content. For instance, where the item of media content is a television show, a salient segment might comprise a scene in which a famous guest star appears or a scene that ends with a cliffhanger; where the item of media content is a comedy sketch show, a salient segment might comprise a news parody segment or a performance by a musical guest; where the item of media content is a movie, a salient segment might comprise a twist ending or a scene featuring three-dimensional effects; where the item of media content is a televised sports event, a salient segment might be a scoring play, a fight, a turnover, or a particularly memorable performance of the national anthem.

In one example, the user interest statistics may be used to identify segments from the item of media content that were most interesting to users, e.g., other users aside from a current user. For instance, the user interest statistics might aggregate metrics such as how many users tuned into the item of media content during presentation of the feature, how many users tuned away from the item of media content during presentation of the feature, how many users replayed the feature while the item of media content was being presented. These metrics might help to identify segments of the item of media content in which user interest was highest or lowest and/or to detect anomalies (e.g., sudden increases or decreases in user interest).

The extracted segments may include overlapping segments (e.g., consecutive scenes of an episode of a television show) and/or disjoint or non-overlapping segments (e.g., two scenes of an episode of a television show, where multiple intervening scenes occur between the two scenes). In one example, any number of segments may be extracted from the item of media content. For instance, the processing system may extract the n segments in which user interest appeared greatest, where n may be any number that is one or greater. Alternatively, the processing system may extract all segments in which the user interest was above a threshold (e.g., based on one or more of the user interest statistics).

In step 206, the processing system may extract one or more salient segments from the item of media content based on at least one selected from a group of: video analytics and audio analytics. For instance, where the item of media content includes a visual component, transitions from one scene to another may be detected through image analysis. For instance, where the item of media content is a sketch comedy show, image analysis may be used to detect when the show transitions from one sketch to another (e.g., sets and/or actors may change); where the item of media content is an episode of a television show, image analysis may be used to detect when the show breaks for commercials (e.g., sets and/or actors may change, product names or known product spokespeople may be prominently displayed).

Where the item of media content includes an audio component, transitions from one scene to another may be detected through audio analysis. For instance, where the item of media content is a movie, audio analysis may be used to detect when one scene transitions to another (e.g., a new set of characters is detected speaking, e.g., via voice recognition, the music changes, and so on); where the item of media content is an episode of a television show, audio analysis may be used to detect when commercial breaks occur (e.g., the volume may increase, voices may change, specific products may be mentioned and so on); where the item of media content is a televised or radio broadcast of a sports event, audio analysis may be used to detect scoring plays, fights, or other events of interest (e.g., crowd noise may increase to more than a threshold above a baseline for the crowd noise, an announcer may call a touchdown, a particular song is played, a horn or bell is sounded, a cannon is fired, or a flag, etc.).

In one example, the processing system may tag any segments that are extracted in order to indicate information about the segments. For instance, a segment that comprises a scoring play from a televised sports event may be tagged to indicate the team and/or players who scored, the manner of scoring (e.g., field goal, passing/rushing/defensive touchdown, safety, etc.), what the resulting game score was, or the time at which the scoring event occurred (e.g., x minutes into a particular quarter of the game, after the two-minute warning, etc.); a segment that comprises a performance by a musical guest on a comedy sketch show may be tagged to indicate the identity of the musical guest or the song(s) that the musical guest performed; a segment that comprises a scene from an episode of a television show may be tagged to indicate the actors who were present in the scene or music that was played in the background of the scene; a segment that comprises a portion of a news broadcast may be tagged to indicate the identity of the anchor who presented the portion or the type of the news presented (e.g., national news, sports, weather, etc.). The segments may be tagged in real time, e.g., as the segments are extracted from the item of media content. In another example, as in step 204, one or more contiguous or non-contiguous scenes may be considered a salient segment because the scenes comprise a single semantic topic or story. For instance, if analytics detected segments based on an actor or a famous location in a news program, the system may determine that multiple scenes should be considered a single segment due to audio or video continuity that binds the scenes as a single story, character montage, or the like (even if the scenes do not explicitly contain the actor or famous location).

In step 208, the processing system may generate a fingerprint for the item of media content based at least on the segments that were extracted using video and/or audio analytics (i.e., as in step 206), where the fingerprint comprises a plurality of markers that identify at least the boundaries of the item of media content (e.g., markers indicating where the item media content begins and ends). The fingerprint may further identify intermediate markers within the item of media content, such as scenes, events, or the like that occur between where the item of media content ends and where the item of media content begins. For instance, the markers may identify one or more of the segments that were extracted (e.g., may identify where in the item of media content the segments occur relative to the start of the item of media content or relative to each other; may identify the durations of the segments; etc.). Collectively, the markers may be used to determine whether a copy of the item of media content is complete (e.g., whether the copy includes all of the markers in the fingerprint). In another example, fingerprints derived from analytics (e.g., as in step 206) may also comprise aggregated statistics of those analytics. For instance, a salient segment may contain a number of analytics like the detection of a car, a road, and an explosion. Collectively, this pattern of analytics may indicate a car chase in an action-based salient sequence. Similarly, a set of analytics including a child, laughter, and gift giving may indicate a holiday moment in a drama or comedy sequence. In contrast (and complement) to fingerprints based on user interest of explicit analytics alone, these examples may also produce genre- or pattern-based fingerprints for the subsequent identification and recovery of salient segments from one or more scenes in longer media content.

In one example, the fingerprint may be further based on the segments that were extracted based on user interest statistics (e.g., as in optional step 204). For instance, any of the segments that were extracted based on the user interests statistics may serve as a marker as described above. Alternatively or in addition, a marker based on user interest statistics may be used to validate or supplement a marker that is based on video and/or audio analytics. For instance, audio analytics may be used to identify the performance of a musical guest on a comedy sketch show, where the performance may serve as a marker. However, the audio analytics may fail to recognize a dramatic entrance that the musical guest makes as a salient part of the performance. By consulting the user interest statistics, however, the processing system may be able to determine that the performance should include a minute and a half of footage that occurs before the musical guest begins singing.

In a further example, the fingerprint may be further based on metadata from an external or third party source (e.g., server 149 of FIG. 1, for instance). For instance, in one example, the metadata may indicate the duration of an item of media content. As an example, the metadata may indicate that a particular episode of a television show is forty five minutes and sixteen seconds long. In another example, the metadata may indicate sounds or images that occur at the beginning and/or end of the item of media content. For instance, the metadata may indicate that the particular episode of the television show begins with a recap of one or more previous episodes and ends with a display of the studio's logo, thirty seconds of outtakes from the episode, or two minutes of director's commentary on the episode. In one example, metadata of the type described above may not be available (or availability may be limited) for live or non-prerecorded items of media content, where certain characteristics (such as duration) may not be known a priori.

In step 210, the processing system may store the fingerprint. For instance, the fingerprint may be stored at a server (e.g., recovery server 115 of FIG. 1, for example) that may operate to help recover missing portions of items of media content in recordings of the items of media content, as described in further detail below. The fingerprint may be stored along with an identifier that identifies the item of media content to which the fingerprint applies.

The method may end in step 212.

The method 200 may be used to generate fingerprints for items of media content that are pre-recorded, such as episodes of television shows, movies, and the like. In this case, pre-recorded items of media content could be at least partially fingerprinted before the items of media content air. The method 200 could also be used to generate fingerprints for items of media content that are broadcast live/not prerecorded, such as televised sports events, award shows, news programs, and the like. In the case of live content, fingerprinting may be performed in substantially real time (e.g., as the live content is airing), or may be performed after the live content airs. Any techniques for generating fingerprints for live content could also be applied to prerecorded content.

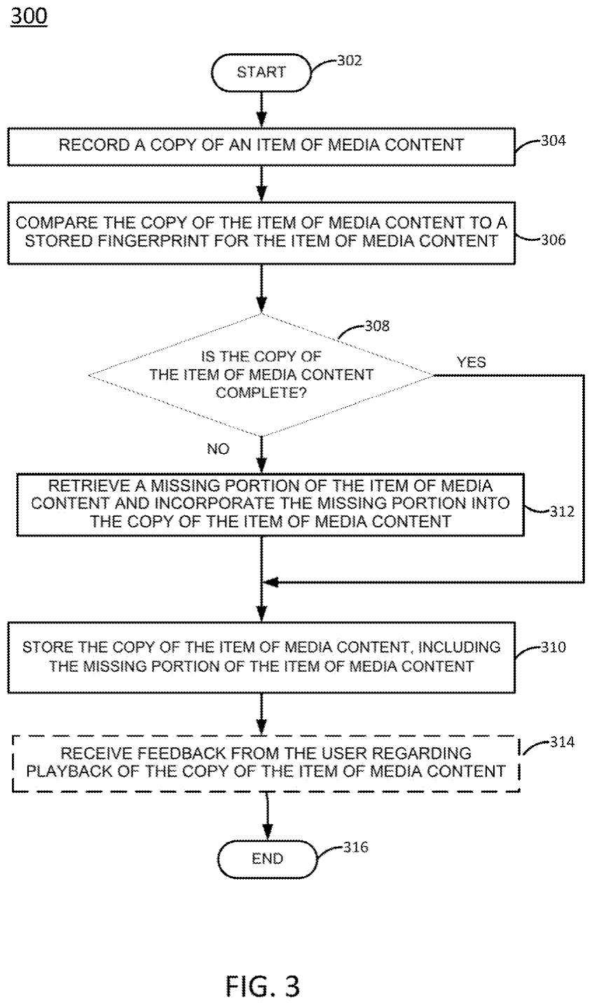

FIG. 3 illustrates a flowchart of an example method 300 for recovering lost media content, in accordance with the present disclosure. In one example, steps, functions and/or operations of the method 300 may be performed by a device as illustrated in FIG. 1, e.g., recovery server 115, user endpoint devices (e.g., mobile devices 157A, 157B, 167A and 167B, and home network devices such as home gateway 161, set-top boxes (STBs) 162A, and 162B, television (TV) 163, home phone 164, router 165, personal computer (PC) 166, immersive display 168, and so forth), or any one or more components thereof. In one example, the steps, functions, or operations of method 300 may be performed by a computing device or system 400, and/or a processing system 402 as described in connection with FIG. 4 below. For instance, the computing device 400 may represent at least a portion of the recovery server 115 in accordance with the present disclosure. For illustrative purposes, the method 300 is described in greater detail below in connection with an example performed by a processing system, such as processing system 402.

The method 300 begins in step 302. In step 304, the processing system may record a copy of an item of media content. As discussed above, the item of media content may comprise an item of audio visual media such as might be presented on a television or other devices including a display. For instance, the item of media content may be an episode of a television show, a movie, a televised sports event, a news program, or the like. However, in other examples, the item of media content may not include a visual component. For instance, the item of media content could be a radio program (e.g., a top 40 countdown, a talk radio program, a radio broadcast of a sports event, or the like).

In one example, the processing system records the item of media content in response to a user request to record the item of media content. For instance, the user may program the processing system to record a particular episode of a sketch comedy show that is scheduled to be hosted by the user's favorite actor. In another example, the user may program the processing system to record every episode of a particular television show (e.g., on the first airings of the episodes). The processing system may be programmed in advance (i.e., before the item of media content airs) to record the item of media content, or the user may request that the processing system record an item of media content that is currently airing (e.g., the user may tune into a movie in the middle of the movie and request that the processing system record the movie).

In one example, the processing system may rely on a predefined schedule in order to determine when and from what source to record the item of media content. For instance, if the processing system is programmed in advance to record a particular episode of a sketch comedy show, the processing system may consult a predefined television programming schedule in order to determine the day, time, and channel on which the particular episode is scheduled to air.

In step 306, the processing system may compare the copy of the item of media content to a stored fingerprint for the item of media content. The fingerprint may, in one example, be retrieved from a remote device. For instance, if the processing system is part of a DVR, the processing system may retrieve the fingerprint (via a network, such as a radio access network) from a remote server. Alternatively, the processing system may be part of a server that performs operations related to recovering lost portions of medic content recordings. In this case, the server may also store the fingerprints or have access to a database that stores the fingerprints.

As discussed above, a fingerprint for an item of media content may comprise a plurality of markers, including at least a first marker that corresponds to the start of the item of media content and a second marker that corresponds to the end of the item of media content. One or more additional markers may correspond to events that occur during the item of media content, between the start and the end. For instance, if the item of media content is an episode of a television show, the first marker might correspond to the playing of the theme song or to a recap of the previous episode of the television show, while the second marker might correspond to the end credits, outtakes, or a preview for the next episode. Intermediate markers might correspond to different scenes that occur at known times within the episode, such as a car chase, a party, a comedic moment, or the like. If the copy of the item of media content is complete, then the copy of the item of media content should include all of the markers in the fingerprint of the item of media content.

In step 308, the processing system may determine whether the copy of the item of media content is complete, based on the comparison. For instance, the item of media content may be an episode of a television show, and broadcast of the episode may have begun later than scheduled (e.g., due to a breaking news alert, or a prior program, such as a sports event, running over its scheduled time), thereby causing the ending of the episode to play after the episode's scheduled ending time. Thus, if the processing system was programmed to record the item of media content only up to the scheduled ending time, then then copy of the item of media content may be missing at least some of the ending of the item of media content, In this case, the copy of the item of media content may be missing at least one marker that is part of the fingerprint of the item of media content (e.g., may be missing at least the marker corresponding to the end, and possibly one or more markers occurring prior to the end marker). Thus, in one example, if the copy of the item of media content is missing at least one marker of the fingerprint of the item of media content, then the copy of the item of media content may be considered incomplete (or a confidence in the completeness of the copy of the item of media content may be low or below a threshold confidence). If, however, the copy of the item of media content includes all of the markers of the fingerprint of the item of media content, then the copy of the item of media content may be considered complete (e.g., with a high confidence or a confidence that is above a threshold confidence).

If the processing system concludes in step 308 that the copy of the item of media content is complete, then the method 300 may proceed to step 310. In step 310, the processing system may store the copy of the item of media content, including the missing portion that was incorporated, if any, e.g., for future play by the user. In one example, the copy of the item of media content may be stored on a user endpoint device in a home network of the user, such as a DVR. In another example, the copy of the item of media content may be stored in a remote database or server that is in communication with the user endpoint device via a network (e.g., a radio access network).

Alternatively, if the processing system concludes in step 308 that the copy of the item of media content is incomplete, then the method 300 may proceed to step 312. In step 312, the processing system may retrieve a missing portion of the item of media content and incorporate the missing portion into the copy of the item of media content. In one example, the processing system may retrieve the missing portion of the item of media content by first identifying what portion is missing. In one example, the processing system may analyze the copy of the item of media content for the latest occurring marker in the copy. For instance, if the item of media content is an episode of a television show, then the latest occurring marker might correspond to a scene that happens seven minutes before the end of the episode.

Next, the processing system may retrieve a portion of the item of media content starting with the latest occurring marker and continuing until the end marker. In one example the portion of the item of media content that is retrieved may be retrieved from a server or other repositories that may store portions (or chunks) of the item of media content. In one example, a plurality of different versions of the portion that the processing system is seeking may exist in different resolutions, bitrates, and the like. In this case, the processing system may select the version that most closely matches the copy of the item of media content (e.g., the version having the same resolution, bitrate, or the like as the copy of the item of media content). The server or other repositories may be an original source of the item of media content (e.g., a VoD source), and thus may store a master copy of the item of media content.

Finally, the processing system may add or concatenate the portion of the item of media content that is retrieved to the copy of the item of media content at the appropriate location. For instance, if the portion if the item of media content that is retrieved occurs at the end of the item of media content as described in the above example, then the portion may be concatenated to the end of the copy of the item of media content (potentially overwriting or replacing the last occurring marker with the beginning of the portion that is retrieved). However, the missing portion of the item of media content could also occur at the beginning (e.g., due to airing of the item of media content beginning earlier than scheduled) or in the middle (e.g., due to temporary loss of network or satellite connectivity, or due to other broadcast interruptions).

Once the missing portion of the item of media content has been retrieved and incorporated into the copy of the item of media content to make the copy complete, the method may then proceed to step 310 as described above.

In optional step 314 (illustrated in phantom), the processing system may receive feedback from the user regarding playback of the copy of the item of media content. In one example, the user feedback may be explicit user feedback indicating whether or not the copy of the item of media content was complete. In another example, the user feedback may comprise an explicit request for or search by the user for a specific segment within the copy of the item of media content. The user feedback may be provided to the device that generates the fingerprints for items of media content, in order to refine the fingerprint generating process and ideally result in more accurate fingerprints that ensure completeness of recorded content in the future.

The method 300 may end in step 316.

The method 300 therefore ensures that copies of items of media content, which may be recorded upon user request for later viewing by the user, are complete. The method 300 relies on fingerprints of the items of media content, which may be generated using machine learning techniques that are capable of identifying salient segments or events in the items of media content.

In further examples, however, the techniques disclosed herein could be used to remove or delete portions of a copy of an item of media content. For instance, certain portions of the copy of the item of media content may not be of interest to the user. Portions that may not be of interest to the user may include, for example commercials, breaking news or weather alerts, and other materials that may be time sensitive or relevant only to the time at which the item of media content is recorded, e.g., special offer for food ordering while show is aired, etc. In another example, specific segments of items of content that are not of interest to the user may be learned or specified by the user. For instance, the user may specify, in recording settings or a profile, that the only portions of a comedy sketch show in which he is interested are the news parody skit and the musical guest performance. Alternatively, a device may learn over time that the user always skips through recordings of the comedy sketch show to get to the news parody skit and the musical guest performances. In this case, when the comedy sketch show is recorded for the user, the copy of the comedy sketch show may be processed to remove all portions of the show except for the news parody skit and musical guest performances. Thus, the user will be able to watch the segments in which he is interested without having to fast forward through a lot of content in which he is not interested. Removing portions of the copy of the comedy sketch show that are not of interest to the user may also save storage space. A notification can also be optionally provided to the user indicating the parameters that were used for the removal of certain portions of the programming so that the user can provide feedback to the processing system.

In a further example, rather than deleting portions that are not of interest to the user, the portions that are of interest to the user may be bookmarked for easier access. For instance, pointers to the portions of interest may be inserted into the copy of the item of media content in order to enable the user to find the portions of interest more quickly. In this case, the rest of the item of media content is also preserved in case the user decides to play any portions that he does not normally play. For instance, referring again to the comedy sketch show example, the user may decide that he wants to watch all of the skits of a particular episode because his favorite actor hosted the episode.

It should be noted that the methods 200 and 300 may be expanded to include additional steps or may be modified to include additional operations with respect to the steps outlined above. In addition, although not specifically specified, one or more steps, functions, or operations of the methods 200 and 300 may include a storing, displaying, and/or outputting step as required for a particular application. In other words, any data, records, fields, and/or intermediate results discussed in the methods can be stored, displayed, and/or outputted either on the device executing the methods or to another device, as required for a particular application. Furthermore, steps, blocks, functions or operations in FIG. 2 or FIG. 3 that recite a determining operation or involve a decision do not necessarily require that both branches of the determining operation be practiced. In other words, one of the branches of the determining operation can be deemed as an optional step. Furthermore, steps, blocks, functions or operations of the above described methods can be combined, separated, and/or performed in a different order from that described above, without departing from the examples of the present disclosure.

FIG. 4 depicts a high-level block diagram of a computing device or processing system specifically programmed to perform the functions described herein. As depicted in FIG. 4, the processing system 400 comprises one or more hardware processor elements 402 (e.g., a central processing unit (CPU), a microprocessor, or a multi-core processor), a memory 404 (e.g., random access memory (RAM) and/or read only memory (ROM)), a module 405 for recovering lost media content, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the methods 200 and 300 as discussed above are implemented in a distributed or parallel manner for a particular illustrative example, i.e., the steps of the above methods 200 and 300 or the entire methods 200 and 300 are implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed methods 200 and 300. In one example, instructions and data for the present module or process 405 for recovering lost media content (e.g., a software program comprising computer-executable instructions) can be loaded into memory 404 and executed by hardware processor element 402 to implement the steps, functions, or operations as discussed above in connection with the illustrative methods 200 and 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 405 for recovering lost media content (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
recording, by a processing system including at least one processor, a copy of an item of media content;
comparing, by the processing system, the copy of the item of media content to a stored fingerprint for the item of media content;
determining, by the processing system, that the copy of the item of media content is missing a portion of the item of media content, based on the comparing;
retrieving, by the processing system, the portion of the item of media content that is missing;
incorporating, by the processing system, the portion of the item of media content that is missing into the copy of the item of media content; and
storing, by the processing system, the copy of the item of media content, including the portion of the item of media content that is missing.

2. The method of claim 1, wherein the stored fingerprint for the item of media content comprises a plurality of markers, wherein each marker of the plurality of markers corresponds to a segment of the item of media content.

3. The method of claim 2, wherein the plurality of markers includes:
a first marker corresponding to a start of the item of media content;
a second marker corresponding to an end of the item of media content; and
an intermediate marker corresponding to a segment of the item of media content occurring between the start of the item of media content and the end of the item of media content.

4. The method of claim 2, wherein the determining comprises:
searching, by the processing system, the copy of the item of media content for the plurality of markers; and
detecting, by the processing system, that a marker of the plurality of markers does not occur in the copy of the item of media content.

5. The method of claim 4, wherein the portion of the item of media content includes the marker of the plurality of markers that does not occur in the copy of the item of media content.

6. The method of claim 2, wherein at least some markers of the plurality of markers are detected in the copy of the item of media content based on video analytics.

7. The method of claim 6, wherein the video analytics include identifying scene transitions within the item of media content.

8. The method of claim 2, wherein at least some markers of the plurality of markers are detected in the copy of the item of media content based on audio analytics.

9. The method of claim 8, wherein the audio analytics include identifying scene transitions within the item of media content.

10. The method of claim 2, wherein at least some markers of the plurality of markers are detected in the copy of the item of media content based on user interest statistics for the item of media content.

11. The method of claim 10, wherein the user interest statistics include a number of times that users replayed a segment of the item of media content.

12. The method of claim 1, wherein the recording is performed during a day and a time and on a channel that are predefined by a programming schedule.

13. The method of claim 12, wherein the portion of the item of media content was aired outside of the time that is predefined by the programming schedule.

14. The method of claim 13, wherein the item of media content is a television program for which a scheduled air time was delayed due to a prior television program running beyond a scheduled time.

15. The method of claim 1, wherein the copy of the item of media content, including the portion of the item of media content that is missing, is stored on a device in a home network of a user.

16. The method of claim 15, wherein the recording is performed in response to a request from the user to record the item of media content.

17. The method of claim 1, further comprising:
receiving, by the processing system, feedback from a user regarding a playback of the copy of the item of media content, including the portion of the item of media content that is missing, wherein the feedback is used to refine a technique used to generate the stored fingerprint for the item of media content.

18. The method of claim 1, wherein the portion of the item of media content that is missing is selected from among multiple versions of the portion of the item of media content that is missing, wherein each version of the multiple versions is encoded at a different bitrate.

19. A non-transitory computer-readable medium storing instructions which, when executed by a processing system including at least one processor, cause the processing system to perform operations, the operations comprising:
recording a copy of an item of media content;
comparing the copy of the item of media content to a stored fingerprint for the item of media content;
determining that the copy of the item of media content is missing a portion of the item of media content, based on the comparing;
retrieving the portion of the item of media content that is missing;
incorporating the portion of the item of media content that is missing into the copy of the item of media content; and
storing the copy of the item of media content, including the portion of the item of media content that is missing.

20. A device comprising:
a processing system including at least one processor; and
a non-transitory computer-readable medium storing instructions which, when executed by the processing system, cause the processing system to perform operations, the operations comprising:
recording a copy of an item of media content;
comparing the copy of the item of media content to a stored fingerprint for the item of media content;
determining that the copy of the item of media content is missing a portion of the item of media content, based on the comparing;
retrieving the portion of the item of media content that is missing;
incorporating the portion of the item of media content that is missing into the copy of the item of media content; and
storing the copy of the item of media content, including the portion of the item of media content that is missing.
